(19) United States
(12) Patent Application Publication
(10) Pub. No.: US 2013/0110900 A1
(43) Pub. Date: May 2, 2013

(54) SYSTEM AND METHOD FOR CONTROLLING AND CONSUMING CONTENT

(71) Applicants: George Thomas Des JARDINS, Washington, DC (US); Andrew COHEN, Plymouth Meeting, PA (US); Piers LINGLE, Bryn Mawr, PA (US); Mark DAWSON, Wayne, PA (US)

(72) Inventors: George Thomas Des JARDINS, Washington, DC (US); Andrew COHEN, Plymouth Meeting, PA (US); Piers LINGLE, Bryn Mawr, PA (US); Mark DAWSON, Wayne, PA (US)

(73) Assignee: COMCAST CABLE COMMUNICATIONS, LLC, Philadelphia, PA (US)

(21) Appl. No.: 13/284,354

(22) Filed: Oct. 28, 2011

(51) Int. Cl. G06F 15/16

(52) U.S. Cl. 709/201

(57) ABSTRACT

A system and method for controlling and consuming content are disclosed. The method, in one aspect, provides for rendering first content on a first device and rendering second content on a second device in response to a signal from the first device. The second content may be contextually related to the first content.

### BACKGROUND

Currently, content can be provided to a user though any number of devices. However, in order to control the content provided by a particular device, a user typically must manually interact with the device. Typically, each manufacturer provides a unique interface program to enable a user to control the content provided by a particular device and devices having different manufacturers are often incompatible. Furthermore, the current content control tools do not provide a sufficient means to contemporaneously control content being rendered on several devices.

### SUMMARY

It is to be understood that both the following general description and the following detailed description are exemplary and explanatory only and are not restrictive, as claimed. Provided are methods and systems for controlling content presented to a user. The system and methods of the present disclosure can be used to synchronize content provided to a user through several devices. The systems and methods of the present disclosure can be used to control content provided to a particular device so that the content can be related in context and/or time to content provided by another device.

In an aspect, a method for controlling content can comprise rendering first content on a first device and rendering second content on a second device in response to a signal from the first device. The second content may contextually relate to the first content.

In another aspect, a method for controlling content can comprise rendering a content control element on a first device and receiving an activation of the content control element, whereby a signal is transmitted from the first device to a second device to control second content rendered by the second device. A first content rendered by the first device may contextually relate to the second content rendered by the second device in response to the activation of the content control element.

In a further aspect, a media system can comprise a first device for rendering first content and a communication element in communication with the first device and a second device, wherein the communication element transmits a signal to the second device to control second content rendered by the second device. The second content may contextually relate to the first content.

In a further aspect, a media system can comprise a plurality of devices for rendering content and a processor in signal communication with each of the plurality of devices. The processor can be configured to receive first content data and second content data, wherein the first content data can contextually relate to the second content data. The processor can be configured to route the first content data to a first one of the plurality of devices and the second data to a second one of the plurality of devices based upon an attribute of the first content data and an attribute of the second content data.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system;

FIG. 2 is a block diagram on an exemplary system;

FIG. 3 is a flow chart of an exemplary method of controlling content presented to a user;

FIG. 4 is a block diagram on an exemplary system;

FIG. 5 is a flow chart of an exemplary method of controlling content presented to a user;

FIG. 6 is a block diagram on an exemplary system;

FIG. 7 is a flow chart of an exemplary method of controlling content presented to a user; and

FIG. 8 is a block diagram of an exemplary computing system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As described in greater detail below, a system can be configured to control presentation of various types of content on a plurality of devices such that the content presented on each of the plurality of devices can be contextually related.

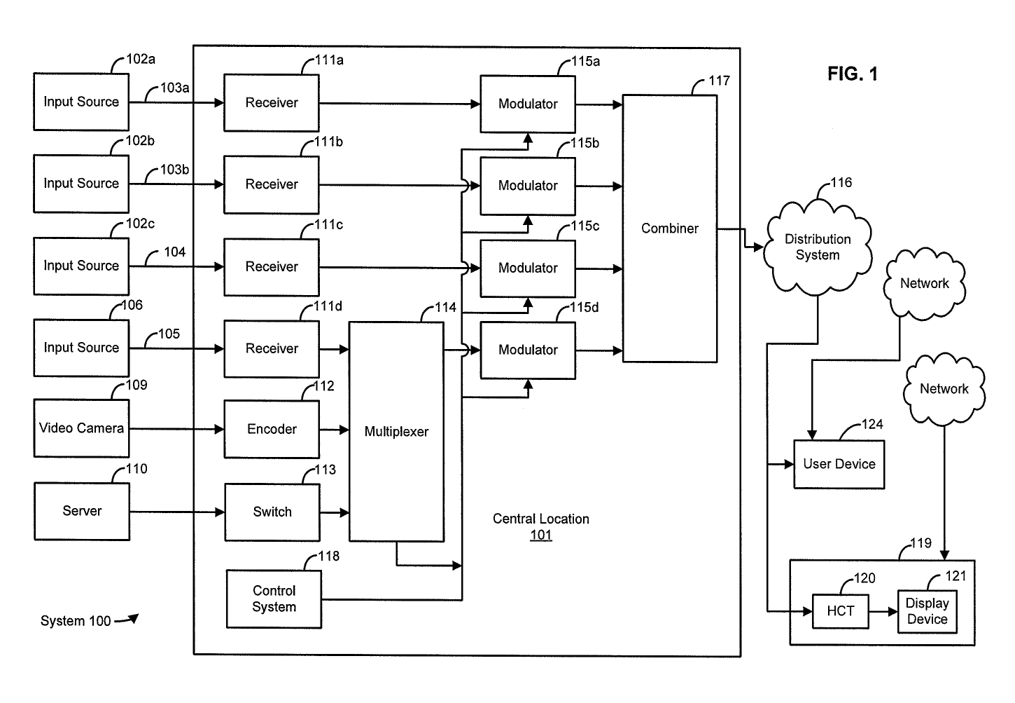

FIG. 1 illustrates various aspects of an exemplary system in which the present methods and systems can operate. The present disclosure relates to systems and methods for controlling content presentation. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system 100 can comprise a central location 101 (e.g., a headend, a processing center, etc.), which can receive content (e.g., data, input programming, and the like) from multiple sources. The central location 101 can combine the content from the various sources and can distribute the content to user (e.g., subscriber) locations (e.g., location 119) via distribution system 116.

In an aspect, the central location 101 can create content or receive content from a variety of sources 102a, 102b, 102c. The content can be transmitted from the source to the central location 101 via a variety of transmission paths, including wireless (e.g. satellite paths 103a, 103b) and terrestrial path 104. The central location 101 can also receive content from a direct feed source 106 via a direct line 105. Other input sources can comprise capture devices such as a video camera 109 or a server 110. The signals provided by the content sources can include, for example, a single content item or a multiplex that includes several content items. In an aspect, the central location 101 can create and/or receive application, such as interactive applications. Such applications can be related to a particular content.

The central location 101 can comprise one or a plurality of receivers 111a, 111b, 111c, 111d that are each associated with an input source. For example, MPEG encoders such as encoder 112, are included for encoding local content or a video camera 109 feed. A switch 113 can provide access to server 110, which can be a Pay-Per-View server, a data server, an internet router, a network system, a phone system, and the like. Some signals may require additional processing, such as signal multiplexing, prior to being modulated. Such multiplexing can be performed by multiplexer (mux) 114.

The central location 101 can comprise one or a plurality of modulators, 115a, 115b, 115c, and 115d, for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of system 100. The control system 118 can interface, monitor, and/or control a variety of functions, including, but not limited to, the channel lineup for the television system, billing for each user, conditional access for content distributed to users, and the like. Control system 118 can provide input to the modulators for setting operating parameters, such as system specific MPEG table packet organization or conditional access information. The control system 118 can be located at central location 101 or at a remote location.

The distribution system 116 can distribute signals from the central location 101 to user locations, such as user location 119. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. At user location 119, there may be an interface comprising a decoder 120, such as a gateway or home communications terminal (HCT) can decode, if needed, the signals for display on a display device 121, such as on a television set (TV) or a computer monitor. Various wireless devices may also be connected to the network at, or proximate, user location 119. Those skilled in the art will appreciate that the signal can be decoded in a variety of equipment, including an HCT, a computer, a TV, a monitor, or satellite dish. In an exemplary aspect, the methods and systems disclosed can be located within, or performed on, one or more HCT's 120, display devices 121, central locations 101, DVR's, home theater PC's, and the like.

In an aspect, user location 119 is not fixed. By way of example, a user can receive content from the distribution system 116 on a mobile device such as a laptop computer, PDA, smartphone, GPS, vehicle entertainment system, portable media player, and the like.

In an aspect, a user device 124 can receive signals from the distribution system 116 for rendering content on the user device 124. As an example, rendering content can comprise providing audio and/or video, displaying images, facilitating an audio or visual feedback, tactile feedback, and the like. However, other content can be rendered via the user device 124. In an aspect, the user device 124 can be an HCT, a set-top box, a television, a computer, a smartphone, a laptop, a tablet, a multimedia playback device, a portable electronic device, and the like. As an example, the user device 124 can be an Internet Protocol compatible device for receiving signals via a network such as the Internet or some other communications network for providing content to the user. It is understood that other display devices and networks can be used. It is further understood that the user device 124 can be a widget or a virtual device for displaying content in a picture-in-picture environment such as on the TV 121, for example.

In an aspect, the methods and systems can utilize digital audio/video compression such as MPEG, or any other type of compression. The Moving Pictures Experts Group (MPEG) was established by the International Standards Organization (ISO) for the purpose of creating standards for digital audio/video compression. The MPEG experts created the MPEG-1 and MPEG-2 standards, with the MPEG-1 standard being a subset of the MPEG-2 standard. The combined MPEG-1, MPEG-2, MPEG-4, and subsequent MPEG standards are hereinafter referred to as MPEG. In an MPEG encoded transmission, content and other data are transmitted in packets, which collectively make up a transport stream. In an exemplary aspect, the present methods and systems can employ transmission of MPEG packets. However, the present methods and systems are not so limited, and can be implemented using other types of transmission and data.

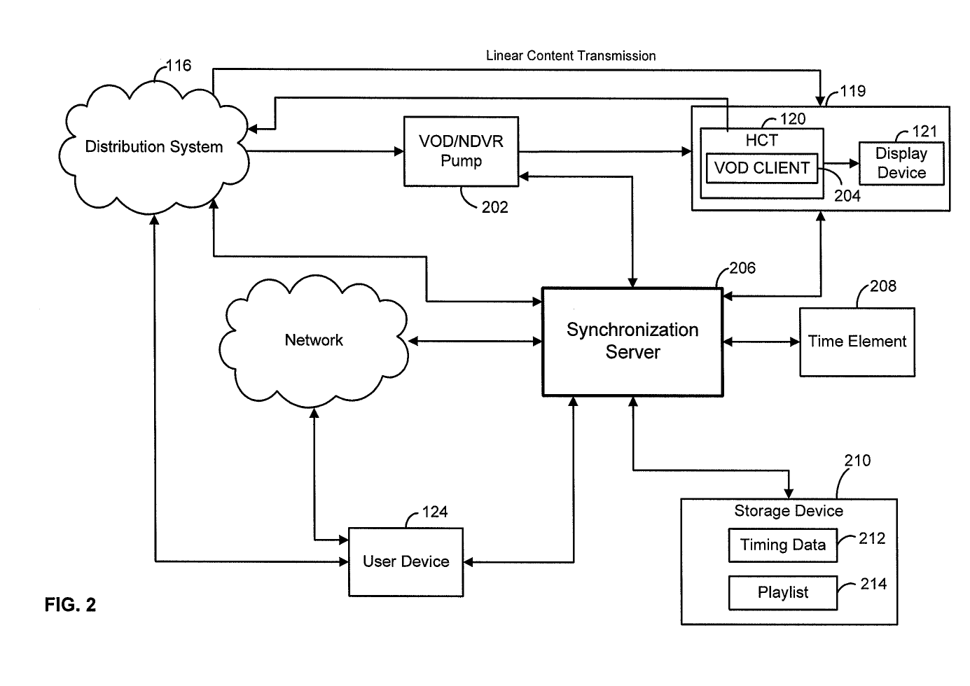

FIG. 2 illustrates various aspects of an exemplary system in which some of the disclosed methods and systems can operate. As an example, the distribution system 116 can communicate with the HCT 120 at the user location 119 via a linear transmission. As a further example, the distribution system 116 can transmit signals to a video on demand (VOD) pump 202 or network digital video recorder pump for processing and delivery to the user location 119.

In an aspect, the HCT 120 or a set-top box can comprise a software component such as VOD client 204 to communicate with a VOD server (e.g., server 110). The VOD client 204 can communicate requests to the VOD server or a VOD management system in communication with the VOD server to configure the VOD pump 202 to transmit content to the HCT 120 for displaying the content to a user. Other content distribution systems can be used to transmit content signals to the user location 119. The foregoing and following examples of video transmissions are also applicable to transmission of other data.

In an aspect, the user device 124 can receive content from the distribution system 116, the Internet Protocol network such as the Internet, and/or a communications network such as a cellular network, for example. Other network and/or content sources can transmit content to the user device 124. As an example, the user device 124 can receive streaming data, audio and/or video for playback to the user. As a further example, the user device 124 can receive user experience (UX) elements such as widgets, applications, and content for display via a human-machine interface. In an aspect, user device 124 can be disposed inside or outside the user location 119.

In an aspect, a synchronization server 206 can be in communication with the distribution system 116, the HCT 120, the user device 124, the Internet, and/or a communication network to receive information relating to content being delivered to a particular user. As an example, other communications elements such as software, virtual elements, computing devices, router devices, and the like, can comprise or serve as a synchronization server 206. As a further example, the synchronization server 206 can associate or map the user device 124 to a particular HCT 120 for synchronizing content delivered to each of the user device 124 and the HCT 120, as described in further detail herein. In an aspect, the synchronization sever 206 can be disposed remotely from the user location 119. However, the synchronization server 206 can be disposed anywhere, including at the user location 119 to reduce network latency, for example.

In an aspect, a time element 208 can be in communication with at least the synchronization server 206 to provide a timing reference thereto. As an example, the time element 208 can be a clock. As a further example, the time element 208 can transmit information to the synchronization server 206 for associating a time stamp with a particular event received by the synchronization server 206. In an aspect, the synchronization server 206 can cooperate with the time element 208 to associate a time stamp with events having an effect on the content delivered to the HCT 120 and/or the user device 124 such as, for example, a channel tune, a remote tune, remote control events, playpoint audits, playback events, program events including a program start time and/or end time and/or a commercial/intermission time, and/or playlist timing events, and the like.

In an aspect, a storage device 210 can be in communication with the synchronization server 206 to allow the synchronization server 206 to store and/or retrieve data to/from the storage device 210. As an example, the storage device 210 can store data relating to a timing data 212 and/or a playlist 214 of content transmitted or scheduled to be transmitted to the HCT 120 and/or the user device 124. As a further example, the storage device 210 can store information relating to users, user preferences, and user devices and configurations. In an aspect, the storage device 210 stores information relating to a mapping for associating particular user devices 124 and HCT's 120 with each other and with particular users. Other storage devices can be used and any information can be stored and retrieved to/from the storage device 210 and/or other storage devices. In an aspect, a synchronization registration event is sent by a connected device, such as the user devices 124 and HCT's 120, to the synchronization server 206. As an example, the synchronization server 206 can assume synchronization has been achieved and proxy the synchronization registration event for the devices.

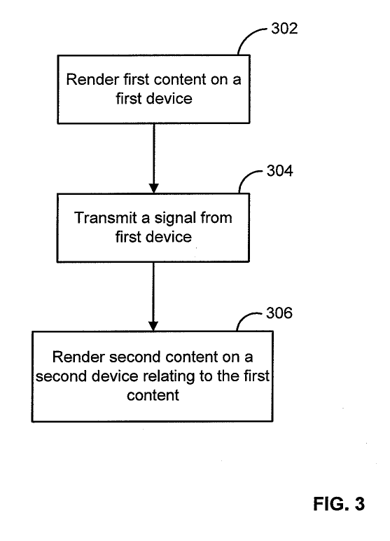

FIG. 3 illustrates a method for controlling media content presented to a user. In step 302, first content can be rendered on a first device such as the HCT 120. As an example, the first content can be obtained via a linear transmission, the VOD pump 202, and/or the Internet or other network. It is understood that the first content can also or instead be rendered on the user device 124.

In step 304, a synchronization signal can be transmitted from the first device to one or more of the synchronization server 206 and a second device such as another HCT or user device, for example. As an example, the synchronization signal is transmitted from the first device directly to the second device. As a further example, the synchronization signal is transmitted from the first device to the synchronization server 206. In an aspect, the synchronization server 206 can receive synchronization signals from a plurality of devices and can process the synchronization servers to control content presentation on the plurality of devices.

In an aspect, the synchronization signal comprises information relating to events having an effect on the content delivered to the first device and the operation of the first device such as a channel tune, a remote tune, remote control events, playpoint audits, playback events, related information or content, and the like. As an example, each of the events can be associated with a time stamp. In an aspect, the synchronization signal comprises tuning information to cause a device receiving the tuning information to tune to a specific source of content and/or render content that can be contextually related to the first content rendered on the first device. As an example, the synchronization signal can be transmitted to and from the synchronization server 206 via hardwire, such as, coax, Ethernet, twisted pair, and the like. As a further example, the synchronization signal can be transmitted to and from the synchronization server 206 via wireless communication, such as, infrared, radio, visible light, sound, and the like. Other forms of wired and wireless communication can be used. In an aspect, a synchronization event is used to communicate between the various connected devices such as the user devices 124 and HTC's 120, for example. As an example, the synchronization event can comprise an XML blob encapsulated in a protocol buffer, a private_command field from the splice command group in the ANSI/STCE 35 2007 Digital Program Insertion Cueing Message for Cable, other messages, or the like. As a further example, the user device 124 can tune a channel on the display device 121 and the “tune event” triggers the presentation of a complementary content on the user device 124.

In step 306, second content can be rendered on a second device relating to the first content rendered on the first device. As an example, the second content can be rendered on the second device in response to the synchronization signal. As a further example, the second content can be rendered on the second device in response to a control signal from the synchronization server 206 that can be transmitted in response to processing the synchronization signal.

In an aspect, the second device can be the user device 124. In an aspect, the second content can be rendered in response to information represented by the synchronization signal transmitted by the first device. As an example, the second content rendered on the second device can be contextually related to the first content rendered on the first device. It is understood that the second device can be the HCT 120 or some other apparatus or system for presenting content to the user.

In an aspect, first content can be transmitted to the HCT 120 for rendering on the display device 121 such as a TV, monitor, video game terminal, or the like, in response to a program tune instruction using a remote tune infrastructure (not shown). As an example, the remote tune infrastructure can comprise a remote control device for controlling a tuning of the HCT 120 to a source of the first content. As a further example, the remote control can control the first content being delivered to a first device (e.g. the HCT 120) and the first device can transmit a synchronization signal to the synchronization server 206 in response to receiving a control event from the remote control. In an aspect, the synchronization signal comprises information relating to events having an effect on the content delivered to the first device and the operation of the first device such as the program tune instruction and the resultant rendering of the first content. As a further example, each of the events can be associated with a time stamp. The synchronization server 206 can process the synchronization signal received from the first device and/or a metadata of the first content to coordinate the synchronization of content rendered on a second device such as the user device 124.

As an example, the HCT 120 can be tuned to a sports program and a synchronization signal can be transmitted to the synchronization server 206 in response to the tuning event of the HCT 120. The synchronization server 206 can process the synchronization signal and can transmit tuning and timing information to the user device 124 so that the user device 124 can render content related to the sports program transmitted to the HCT 120 such as websites, related images, music, video, subtitles, foreign language translations, tactile feedback, and the like. As a further example, when the sports program rendered on the HCT 120 comprises a commercial break for rendering an advertisement on the TV 121, a synchronization signal can be transmitted from the HCT 120 to the synchronization server 206, the synchronization server 206 can process the synchronization signal, and content rendered on the user device 124 can be modified to relate to the advertisement contemporaneously being rendered on the display device 121, such as a website, related images, promotions, coupons, music, video, interactive advertising, and the like. In an aspect, the user device 124 can transmit a synchronization signal to the synchronization server 206 in order to synchronize content on another device with the content being rendered by the user device 124. Any device can transmit a synchronization signal or content related information to one or more of the synchronization server 206 and other devices (e.g., user device 124) so that the content being delivered to one or more devices can be related in context and time. Remote devices can be synchronized such that multiple users can share in a common experience from remote locations.

In an aspect, the second device can transmit a synchronization signal back to the synchronization server 206. As an example, the synchronization signal comprises information relating to events affecting the content delivered to the second device and the operation of the second device such as a channel tune, a remote tune, remote control events, playpoint audits, and playback events. As a further example, each of the events can be associated with a time stamp. In an aspect, the synchronization signal comprises tuning information to cause a device receiving the tuning information to tune to a specific source of content and/or render content that can be contextually related to the second content rendered on the second device. Accordingly, the synchronization server 206 has up-to-date information relating to the content being rendered on the second device and any control events executed by the second device that may affect synchronization with other devices such as the first device, for example.

In an aspect, the synchronization server 206 can receive synchronization signals from any number of devices in any location. The synchronization server 206 can process the synchronization signals to determine content being rendered on a particular device and a timing related to the rendering and/or modification of the content on the particular device. Accordingly, the synchronization server 206 can control delivery of content to other devices so that the content being delivered to one or more devices can be synchronized and/or related in context and time.

In an aspect, because the consumption of various content may be favored on different platforms in different devices, the synchronization sever 206 can receive content data and/or user experience (UX) data and can route the data to a particular device based upon various attributes of the data. As an example, data attributes can comprise a classification of content, a resolution, a type of encoding, a genre of content, a data size, a data type, or other classification such as a classification based upon the presence of a particular actor or sports figure. As an example, the content data can be routed in response to tags found in metadata or the user's social graph (from social networking sites for example), alerts or RSS feeds the client may have established, through consultation with advertising technology that seeks to place relevant advertising content, or through the source of the content, such as a video chat session.

In an aspect, the content can be distinguished by a user action. For example, a user who selects a tune event may receive real-time voting content (similar to American Idol real-time voting). As a further example, when the user selects a recording event (set a DVR recording), the system may present future TV listing information or the availability of the content “On Demand”, in real-time. Other distinctions of content data can be relied upon to route the content data. In an aspect, the analysis of the content data can be configured in response to explicit and/or inferred instructions or preferences of the end user.

For example, where first content data requires a user input and the user input can be provided by a device coupled to the HCT 120, then the first content data can be directed to the HCT 120 by the synchronization server 206. Similarly, if the user generally prefers to render high definition content through a particular HCT 120 or user device 124, the synchronization server 206 can determine the user preferences for high definition content and direct the content data representing high definition content to the particular HCT 120 or user device 124. It is understood that the synchronization server 206 can resolve conflicts between various devices relating to the timing and transmission of content and content data based upon at least a set of decision rules and user priorities. Multiple data inputs such as multiple camera angles, multiple video streams, and multiscreen presentations can be coordinated by the synchronization server 206 to direct the content to an appropriate device for rendering.

In an aspect, several tablets/laptops or other user devices 124 can be synchronized based upon a media stream or content data transmitted to the HCT 120. For example, advertisements and banners displayed on the user devices 124 can relate to content currently being rendered on the TV 121 through the HCT 120. As a further example, synchronization information relating to the content being rendered on the user device 124 and the timing of a user interaction with the content on the user device 124 can be transmitted to the synchronization server 206 for processing. Accordingly, the content rendered on other devices can be controlled to relate to an interaction of the user with the user device 124. For example, if a user navigates to social networking site on the user device 124, other devices can be controlled to render unique content relating to the particular social networking site.

In an aspect, various consumer products can be configured to operate as the user device 124. For example, an appliance such as a refrigerator can be configured to communicate with the synchronization server 206. Accordingly, if the user interacts with the user device 124 to indicate an interest in an advertisement for milk, the refrigerator can receive the information from the one or more of the user device 124 and the synchronizations server 206 and automatically update a digital grocery list rendered on the refrigerator to include milk. Similarly, a digital picture frame can be configured to communicate with one or more of the user device 124 and the synchronization server 206. In an aspect, a data can be stored locally or remotely on a storage device and can be retrieved by a device for rendering. As an example, the digital picture frame can include a memory having a plurality of catalogued digital images. As a further example, the digital picture frame can be in communication with a remote database or service for providing various images to the digital picture frame. Accordingly, when content rendered on the display device 121 includes a beach, the digital picture frame can be controlled to retrieve and display beach related pictures. Other devices can be configured to communicate with one or more of the user device 124 and the synchronization server 206 in order to contextually relate the content being rendered on various devices. Various sources of content can also be used such as third-party databases and content service providers.

As described in greater detail below, a first device for rendering first content can be configured to control second content rendered on a second device such that the first content and the second content are related in content and/or time.

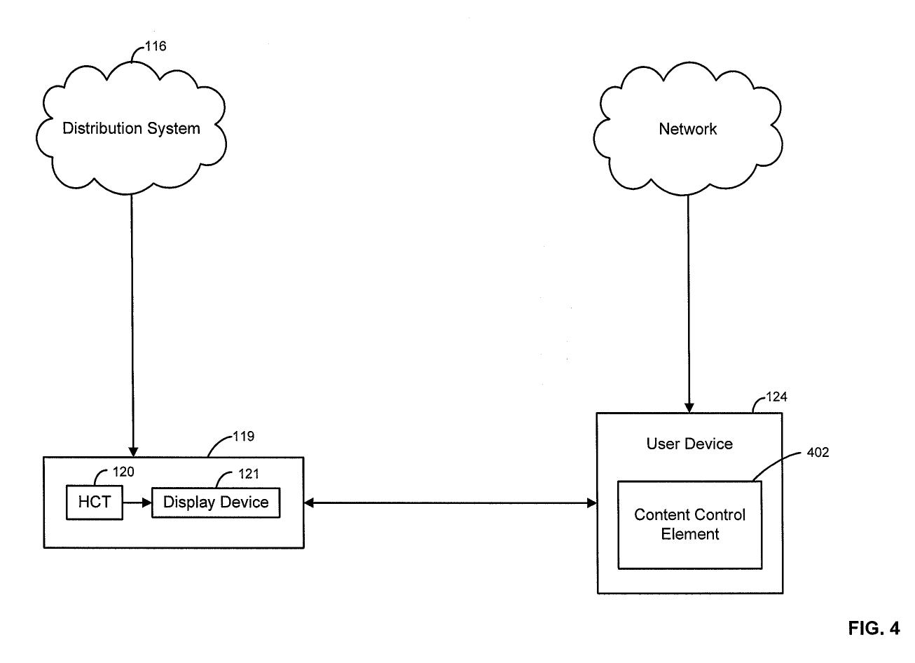

FIG. 4 illustrates various aspects of an exemplary system in which the present methods can operate. As an example, the distribution system 116 can communicate with the HCT 120 at the user location 119 via a linear or non-linear transmission. Any means of transmitting content to the HCT 120 can be used, such as broadcast, multicast, unicast, etc.

In an aspect, the user device 124 can receive content from the distribution system 116 and/or network such as the Internet, for example. As an example, the user device 124 can receive streaming audio and/or video for playback to the user. As a further example, the user device 124 can receive user experience (UX) elements such as widgets, applications, and content for display via a human-machine interface. In an aspect, first content rendered on the user device 124 comprises content control element 402. As an example, the content control element 402 can be a user selectable element such as a virtual button, a “Watch Now” button, a “Record Now” button, a “Share” button, or the like. Other user selectable elements or user interface elements can be used. In an aspect, the content control element 402 can be a text or graphic rendered by the user device 124 and accessible/executable using a remote, a touch screen, a mouse, or other interface device.

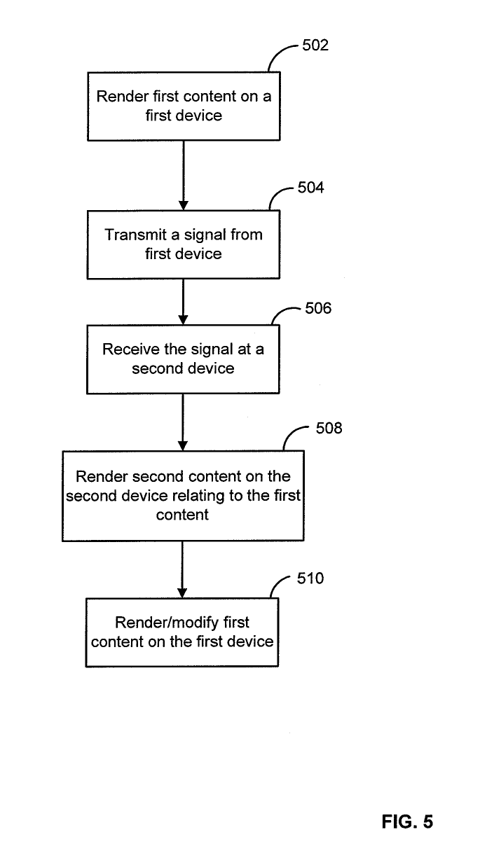

FIG. 5 illustrates a method for controlling media presented to a user. In step 502, first content can be rendered on a first device such as the user device 124, for example. In an aspect, the first content comprises the content control element 402.

In step 504, the content control element 402 can be selected or activated, thereby causing a synchronization signal to be transmitted from the first device. As an example, a user can activate the content control element 402 by touching the rendering of the content control element 402 on a touch screen of the first device. As a further example, the user can activate the content control element 402 by selecting the content control element 402 using a mouse, a cursor, a remote control, or other similar device. In an aspect, the user can activate or select the content control element 402 using other means such as voice prompts, gestures, or other recognition systems.

In an aspect, the synchronization signal transmitted from the first device can be received by a second device, at step 506. The synchronization signal can be directly or indirectly received from one or more of another user device 124, the HCT 120, and of media display devices. As an example, the synchronization signal can be received directly from the first device. However, the synchronization signal can be routed through other devices, switches, servers, systems, and the like. As a further example, the synchronization signal can be received by the synchronization server 206, analyzed by the synchronization server 206, and routed to the second device, as shown in FIG. 2. The signal can be received by the second device in the original transmitted form or as a secondary signal generated and transmitted based upon the original signal, as appreciated by one skilled in the art. In an aspect, the synchronization signal can be transmitted from the second device. As an example, the synchronization signal can be transmitted from the second device. As a further example, the synchronization signal can be transmitted in response to an activation of the content control element 402 rendered or disposed on the first device or second device. In an aspect, the second device can transmit the synchronization signal to the first device to control a content rendered on the first device. Other triggering events can cause the synchronization signal to be transmitted from one or more devices.

In step 508, the second device can process the synchronization signal to control second content presented by the second device. In an aspect, the synchronization signal comprises at least one of tuning information for tuning the second device to a specific source of the second content; control information for causing the second device to record the second content; and synchronization information relating to the rendering of the first content. Any information can be included in the synchronization signal and processed by the second device, as desired. As an example, the second content can comprise an audio or video feedback to the user. However, any media or feedback can be presented to the user via the second media device.

In step 510, which may or may not be performed, first content can be rendered or modified on the first device in response to activating the content control element 402. In an aspect, the first content can be rendered or modified to relate to the second content provided by the second device. As example, once the content control element 402 is activated or selected, the first content can be updated or changed to have a contextual relationship to the second content provided by the second device. As a further example, the first content and the second content are synchronized so that a change in one of the first and second content can be recognized to cause a change in the other of the first and second content to maintain the contextual relationship therebetween.

As an example, the first device can be an Internet Protocol compatible device such as a laptop, smartphone, or ipad® tablet, and the second device can be a terminal or computer logically coupled to a display. It is understood that each of the first device and the second device can be any device, such as a set top box, a laptop, a smartphone, a tablet, a handheld consumer electronic device, and the like. As an example, the first device is a main display device and the second device is a combination display device and remote control for controlling the first device. The first device can comprise software or other application for controlling the second device. In an aspect, the software can be virtual remote control software for tuning the second device or controlling a record function of the second device. It is understood that the software can control a rendering of the content control element 402 on the first device. Accordingly, the first device can render the first content including information about the available programming of a given media channel. Once the user identifies programming of interest, the user can activate/select the content control element 402 associated with the programming of interest. In other words, the user can search through a catalog of programs and select the one the user desires to watch. Once the content control element 402 is activated, the programming of interest can be rendered on the second device as the second content. Additionally, the first content displayed on the first device is updated to render information contextually related to the programming of interest now being rendered on the second device. As an example, the first content can be a show synopsis, a cast, a forum, statistics, event standings, an interactive game, promotional media, or any other related feedback. Accordingly, the user can be provided with relevant information about the second content provided by the second device. The updated first content provides a media space that can be leveraged by various entities to reach a captive audience (i.e. the user), wherein the user has demonstrated a clear interest in the selected content.

As described in greater detail below, a system can be configured to control presentation of content on a device using a video encoded invisible light signal.

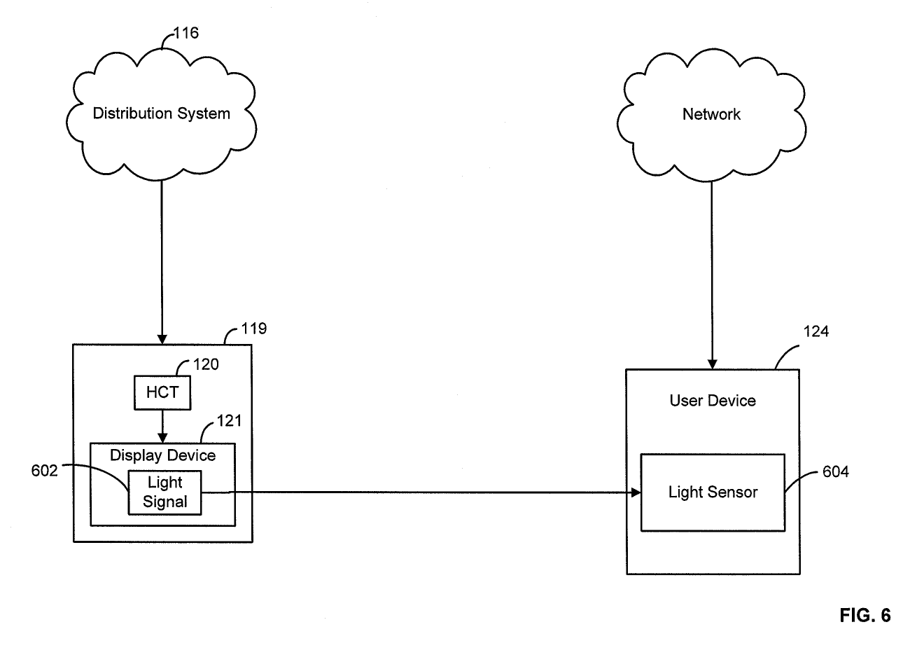

FIG. 6 illustrates various aspects of an exemplary system in which the present methods operate. As an example, the distribution system 116 can communicate with the HCT 120 at the user location 119 via a linear transmission. However, other means of transmitting content to the HCT 120 can be used. As a further example, the video signal can comprise video encoded invisible light (VEIL) data to communicate information via a display of the display device 121. Accordingly, the information encoded in the video signal can be rendered on the TV 121 and can be transmitted from the display device 121 as a light signal 602. In an aspect, the VEIL data in the video signal can be processed by a device, such as the display device 121, such that the luminescence of the pixels, lines, or regions of the display is manipulated to display an encode message (e.g. the light signal 602) in the display that is difficult to perceive to the human eye. As an example, the VEIL data can manipulate the average luminescence of alternate lines of the display, wherein a luminescence of one line is slightly raised relative to an average luminescence and an luminescence of an adjacent line is slightly lowered relative to an average luminescence, thereby encoding a bit of information in every pair of lines. Accordingly, a device can be configured to receive the emitted light and process the message (e.g. the light signal 602) presented on the display.

In an aspect, the user device 124 can receive content from the distribution system 116 and/or a network such as the Internet, for example. As an example, the user device 124 can receive streaming audio and/or video for playback to the user. As a further example, the user device can receive user experience (UX) elements such as widgets, applications, and content for display via a human-machine interface. In an aspect, the user device 124 comprises a light sensor 604 configured to receive the light signal 602 and process the information encoded therein.

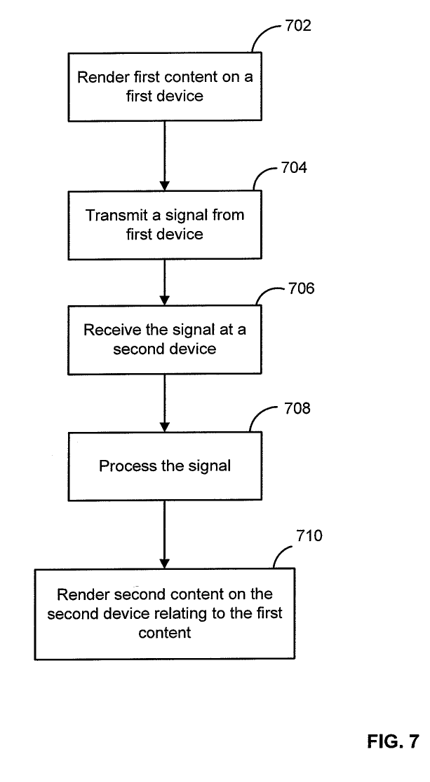

FIG. 7 illustrates a method for controlling media presented to a user. In step 702 first content can be rendered on a first device such as the TV 121. In an aspect, the first content can be a video rendering based upon a video signal. As an example, the video signal comprises a video encoded invisible light data to communicate an information via a display of the first device.

In step 704, the information encoded in the first content rendered on the first device can be transmitted from the first device as the light signal 602. As an example, the light signal 602 can be received by the user as a visually readable signal. As a further example, the light signal 602 can be an invisible light signal representing underlying data. In an aspect, the light signal 602 comprises a universal resource locator (URL) encoded in a feed for the first content and transmitted to the user as an encoded URL in the invisible light signal 602. Any information can be included in the light signal 602 and processed by the second device, as desired.

In an aspect, the light signal 602 can be transmitted from the first device and can be received by the second device, at step 706. As an example, the light signal 602 can be received directly from the first media device. However, the light signal 602 can be routed through other devices, switches, servers, systems, and the like. As a further example, the light signal 602 can be received by the light sensor 604, which can be configured to decode the underlying information encoded in the light signal 602. The light signal 602 can be received by the second device in the original transmitted form or as a secondary signal generated and transmitted based upon the original signal, as appreciated by one skilled in the art. In an aspect, the light signal 602 can be transmitted by the second device and received and processed by the first device.

In step 708, the second device can process the light signal 602 to control the second content provided by the second device. As an example, the light signal 602 can be received by the second device to direct the second device to a particular URL, wherein the webpage associated with the URL includes the second content having a contextual relationship to the first content, as shown in step 710.

In an aspect, the second content can be rendered on the second device relating to the first content provided by the first device in response to information represented by the light signal 602 transmitted by the first device. As an example, the first content and the second content can be synchronized so that a change in one of the first or second content can be recognized to causes a change in the other of the first or second content to maintain the contextual relationship therebetween.

In an aspect, a user can watch a television program (i.e. first content) on a first device such as the TV 121. The first content can comprise a scene having a particular brand of vehicle. The video stream used as the source for the first content can comprise video encoded invisible light data representing a website for the manufacturer of the particular brand of vehicle. Accordingly, at a time when the particular brand of vehicle is displayed on the first device, the light signal 602 can be transmitted from the first device to the second media device, wherein the second device processes the light signal 602 and navigates to a webpage relating to the particular brand of vehicle. It is understood that this process can be automated, causing the second device to automatically navigate to a webpage anytime a light signal 602 is received. It is further understood that the second device can prompt the user for an express instruction to navigate to the webpage represented by the light signal 602. In this way, the user can be presented with relevant information relating to the first content being provided by the first device without disrupting the first content. The light signal 602 can represent any content information and/or tuning information to control the second content. The light signal 602 can provide other information to a receiving device such as a promotion, coupon, advertisement, caption, image, text, and the like. Furthermore, the light signal 602 can direct the receiving device to any file or location.

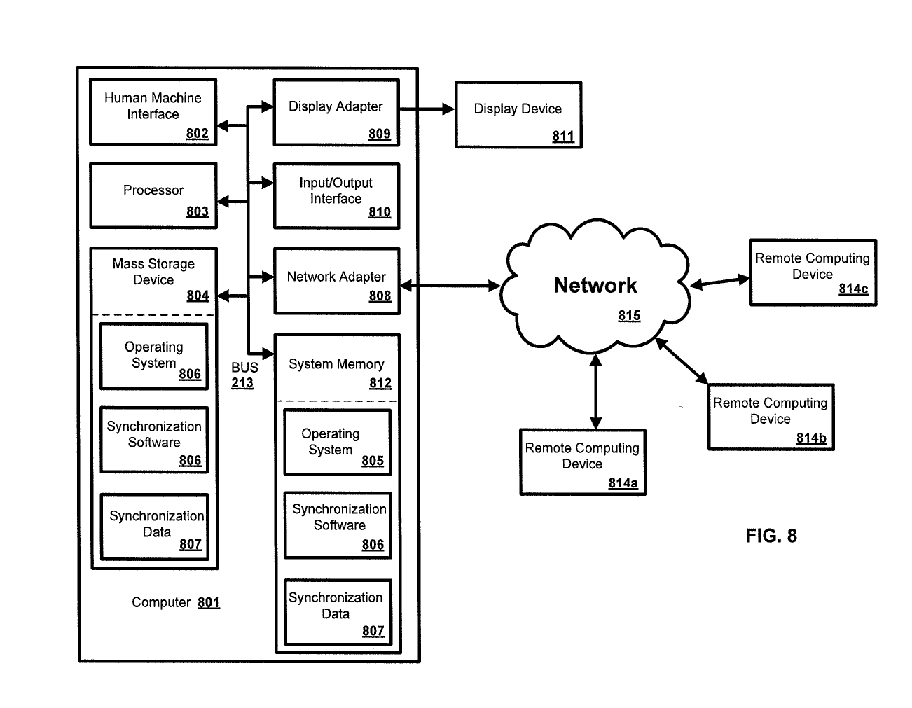

In an exemplary aspect, the methods and systems can be implemented on a computing system such as computer 801 as illustrated in FIG. 8 and described below. By way of example, synchronization server 206 of FIG. 2 can be a computer as illustrated in FIG. 8. Similarly, the methods and systems disclosed can utilize one or more computers to perform one or more functions in one or more locations. FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 801. The components of the computer 801 can comprise, but are not limited to, one or more processors or processing units 803, a system memory 812, and a system bus 813 that couples various system components including the processor 803 to the system memory 812. In the case of multiple processing units 803, the system can utilize parallel computing.

The system bus 813 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and each of the subsystems, including the processor 803, a mass storage device 804, an operating system 805, synchronization software 806, synchronization data 807, a network adapter 808, system memory 812, an Input/Output Interface 810, a display adapter 809, a display device 811, and a human machine interface 802, can be contained within one or more remote computing devices 814a,b,c at physically separate locations, connected through buses of this form, in effect implementing a fully distributed system.

The computer 801 typically comprises a variety of computer readable media. Exemplary readable media can be any available media that is accessible by the computer 801 and comprises, for example and not meant to be limiting, both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as synchronization data 807 and/or program modules such as operating system 805 and synchronization software 806 that are immediately accessible to and/or are presently operated on by the processing unit 803.

In another aspect, the computer 801 can also comprise other removable/non-removable, volatile/non-volatile computer storage media. By way of example, FIG. 8 illustrates a mass storage device 804 which can provide non-volatile storage of computer code, computer readable instructions, data structures, program modules, and other data for the computer 801. For example and not meant to be limiting, a mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and synchronization software 806. Each of the operating system 805 and synchronization software 806 (or some combination thereof) can comprise elements of the programming and the synchronization software 806. synchronization data 807 can also be stored on the mass storage device 804. synchronization data 807 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 801 via an input device (not shown). Examples of such input devices comprise, but are not limited to, a keyboard, pointing device (e.g., a “mouse”), a microphone, a joystick, a scanner, visual systems such as Microsoft's Kinect, audio systems that process sound such as music or speech, a traditional silver remote control, tactile input devices such as gloves, touch-responsive screen, body coverings, and the like These and other input devices can be connected to the processing unit 803 via a human machine interface 802 that is coupled to the system bus 813, but can be connected by other interface and bus structures, such as a parallel port, game port, an IEEE 1394 Port (also known as a Firewire port), a serial port, or a universal serial bus (USB).

In yet another aspect, a display device 811 can also be connected to the system bus 813 via an interface, such as a display adapter 809. It is contemplated that the computer 801 can have more than one display adapter 809 and the computer 801 can have more than one display device 811. For example, a display device can be a monitor, an LCD (Liquid Crystal Display), or a projector. In addition to the display device 811, other output peripheral devices can comprise components such as speakers (not shown) and a printer (not shown) which can be connected to the computer 801 via Input/Output Interface 810. Any step and/or result of the methods can be output in any form to an output device. Such output can be any form of visual representation, including, but not limited to, textual, graphical, animation, audio, tactile, and the like. The display 811 and computer 801 can be part of one device, or separate devices.

The computer 801 can operate in a networked environment using logical connections to one or more remote computing devices 814a,b,c. By way of example, a remote computing device can be a personal computer, portable computer, a smartphone, a server, a router, a network computer, a peer device or other common network node, and so on. Logical connections between the computer 801 and a remote computing device 814a,b,c can be made via a network 815, such as a local area network (LAN) and a general wide area network (WAN). Such network connections can be through a network adapter 808. A network adapter 808 can be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are illustrated herein as discrete blocks, although it is recognized that such programs and components reside at various times in different storage components of the computing device 801, and are executed by the data processor(s) of the computer. An implementation of synchronization software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for consuming content, the method comprising:
rendering first content on a first device; and
rendering second content on a second device in response to a signal from the first device, the second content contextually relating to the first content.

2. The method of claim 1, wherein the signal comprises synchronization information relating to the rendering of the first content.

3. The method of claim 2, wherein the second content is synchronized with the first content in response to the signal.

4. The method of claim 1, wherein the signal comprises tuning information for tuning the second device to a specific source of the second content.

5. The method of claim 1, wherein the first device is an Internet Protocol compatible device having a first display.

6. The method of claim 1, wherein the first device comprises a display and the signal is transmitted as an encoded light.

7. The method of claim 6, wherein the second device includes a light sensor for receiving the encoded light signal.

8. A method comprising:
rendering a content control element on a first device;
receiving an activation of the content control element, whereby a signal is transmitted from the first device to a second device to control second content rendered by the second device; and
rendering first content on the first device contextually relating to the second content rendered by the second device in response to the activation of the content control element.

9. The method of claim 8, wherein the signal comprises tuning information for tuning the second device to a specific source of the second content.

10. The method of claim 8, wherein the signal comprises control information for causing the second device to record the second content.

11. The method of claim 8, wherein the signal comprises synchronization information relating to the rendering of the first content.

12. The method of claim 11, wherein the second content is synchronized with the first content in response to the signal.

13. The method of claim 8, wherein the first device is an Internet compatible device having a first display.

14. The method of claim 8, wherein the content control element is a user selectable element.

15. The method of claim 8, wherein the first content on the first device comprises supplemental information contextually relating to the second content provided by the second device.

16. A system comprising:
a first device for rendering first content; and
a communication element in communication with the first device and a second device, wherein the communication element is adapted to transmit a signal to the second device to control second content rendered by the second device, and wherein the second content is contextually related to the first content.

17. The system of claim 16, wherein the first device is a set top box in signal communication with a display for rendering the first content.

18. The system of claim 17, wherein the communication element is configured to receive data from the first device relating to the first content.

19. The method of claim 16, wherein the signal comprises synchronization information relating to the first content.

20. A system comprising:
a processor in signal communication with at least two devices, the processor configured to:
receive first content data and second content data, wherein the first content data is contextually related to the second content data; and
route the first content data to a first one of the plurality of devices and the second data to a second one of the plurality of devices based upon an attribute of the first content data and an attribute of the second content data.
